(19) United States
(12) Patent Application Publication
(10) Pub. No.: US 2004/0154821 A1
(43) Pub. Date: Aug. 12, 2004

(54) Device for the temporary wiring, especially emergency wiring, or communication networks

(76) Inventor: Michael Neuner, Dreieich (DE)

Correspondence Address: Robert W Becker & Associates, Suite B, 707 Hwy 66 East, Tijeras, NM, 87059-7382, US

(21) Appl. No.: 10/474,141

(22) PCT Filed: Mar. 28, 2002
(86) PCT No.: PCT/EP02/03515

(30) Foreign Application Priority Data
Apr. 4, 2001 (DE) 101 16 649.4

(51) Int. Cl. H02G 1/00

(52) U.S. Cl. 174/68.1

(57) ABSTRACT

The invention relates to a device (2) for the temporary wiring, especially emergency wiring, of communication net-works, comprising a base (4) that has a reel-up device (6) for a cable (10) for linking the device (2) with a central unit (12). Connecting means (8) for connecting a plurality of data processing devices (14) and distributing means linked with the connecting means (8) are provided on the base (4) for producing a communication link between the central unit (12) and the data processing devices (14). The inventive device (2) allows for the fast and simple initiation of a communication network.

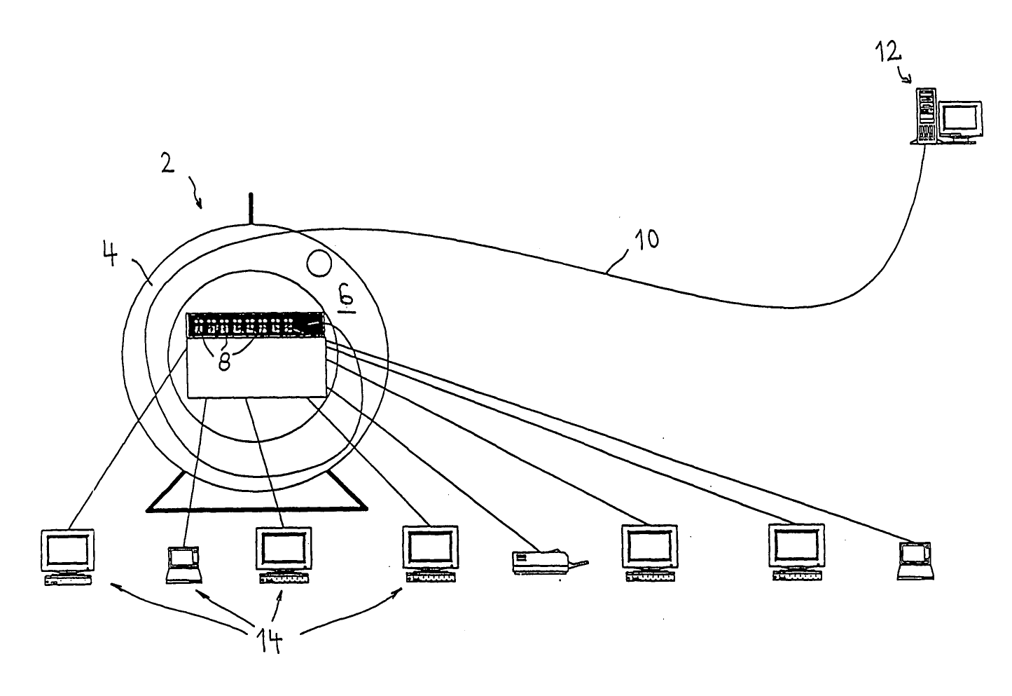

The invention relates to a device for the temporary wiring, especially emergency wiring, of communication networks.

Communication networks, for example data processing networks, are, in many enterprises, an important component of the operating organization, with a smooth progress of the operational success being considerably dependent thereupon. If the data processing network fails or is interrupted, for the department that is affected, or under certain circumstances even for the entire enterprise, this means a considerable adverse effect upon the operational progress and even a complete shutdown of work in the department or enterprise that is affected. Since the operational sequences in a modern enterprise are effected rapidly and in an interactive manner, even a brief interruption of the data processing network is a drawback upon the progress of the enterprise and results in high costs.

If the entire data processing network is interrupted, for example if a plug connection becomes loose or a location of the cabling of the network is damaged, it is necessary to find and eliminate the cause for the interruption as rapidly as possible in order to again make the data process network ready for operation. In practice this often turns out to be difficult and time consuming, since technicians are necessary to eliminate the network interruption. Such technicians must find the cause for the interruption, eliminate it, and subsequently again place the data processing network into operation. This results in high costs.

It is an object of the invention to provide a device that makes it possible to rapidly and economically place the communication network into operation in a straightforward manner.

This object is realized by the teaching provided in claim 1.

The invention is based on the concept of rapidly establishing a temporary wiring in a communication network between a central unit and data processing units that are in a data processing connection with the central unit.

Pursuant to the invention, for the temporary wiring of communication networks, the device is provided with a base that has a winding device for a data transmission line for the connection of the device to a central unit, whereby disposed on the base are connecting means for connecting a plurality of data processing units to the device, and distribution means connected with the connecting means for establishing data processing connections between the central unit and the data processing units.

In this way, the communication network, for example after an interruption caused by a failure in the wiring, can in a straightforward manner be rapidly and economically again be brought into an operational state without technicians being required for this purpose. For example, if a data processing network is interrupted, it is merely necessary to remove a plug of the connecting line connected into the central unit, which connecting line serves for the data processing units connected to the central unit, and to plug the plug of the line in at this location for connecting the inventive device to the central unit. Subsequently, the line is unwound from the winding device of the device, and the device is brought to the data processing units that are to be connected to the central unit. These units are then connected to the device via the connecting means that are provided on the inventive device. Thereafter, the data processing network can again be placed into operation.

The inventive device thus also puts inexperienced personnel in a position to rapidly and without problems place a communication network back into operation, especially after an interruption caused by a failure in the wiring.

If the inventive device is, for example, a device for emergency wiring, the inventive device furthermore offers the advantage that technicians can search for and eliminate the cause of the network failure in peace and with all necessary care during the time that the network operation is temporarily ensured by the inventive device. Furthermore, the inventive device offers the advantage that for times that experience has shown it is difficult to consult with technicians for eliminating a network interruption, for example during a night shift, no particular organizational precautions have to be met, since during an interruption the communication network can again be brought into operation with the aid of the inventive device even by inexperienced personnel.

After the cause for the network interruption is eliminated by technicians, the connection between the central unit and the data processing unit connected thereto, which connection was temporarily established by the inventive device, can again be interrupted in order to reassume normal network operation. Subsequently, the inventive device can again be stowed in a space-saving manner, since pursuant to the invention it can be very compactly designed. However, size, shape and material of the inventive device can, in principle, be selected over a wide range.

The signals exchanged between the central unit and the data processing units can be electrical, optical or other signals. The lines used in the communication network can correspondingly be lines suitable for the transmission of electrical, optical or other signals.

In principle, the distribution means can be designed in any suitable manner. During operation of the inventive device, the distribution means automatically establish data transmission connections between the central unit and the data processing unit or between the data processing units themselves, so that the data processing units exchange data with the central unit or with one another. The distribution means expediently have switch means.

It is furthermore expedient that the distribution means have an active network component. Such network components operate actively and are suitable to automatically rapidly and at high data transmission rates establish data transmission connections between the central unit and the data processingis units, or between the data processing units themselves, as is known in general to one skilled in the art.

It is particularly expedient for the active network component to be a switch, a hub, a router or the like. Such active network components are available as economical standard components having a high efficiency.

Pursuant to a further development of the inventive teaching, the distribution means be provided with amplification means for amplifying signals exchanged between the central unit and the data processing units.

Pursuant to another advantageous further development of the inventive teaching, the line for connecting the device with the central unit is fixedly connected with the base of the device, since in this way an undesired detachment of the line from the base is avoided during unwinding of the line.

Pursuant to a further advantageous further development of the inventive teaching, the connecting means are provided with plug connections for the connection of the data processing units. In this way, a simple and rapid connection of the data processing units to the device is made possible. In this way, the unit plugs provided on the data processing units can also be utilized.

Pursuant to an extremely advantageous further development of the inventive teaching, the base is embodied in the manner of a cable drum, and thus forms the winding device. With this embodiment, the inventive device can be made particularly compact, whereby at the same time a straightforward and nonproblematic winding and unwinding of the line for the connection with the central unit is made possible.

In principle, the distribution means can be disposed in any suitable manner on the base of the device, for example can be fixedly or detachably connected therewith. However, the distribution means are expediently integrated into the base of the device. This has the advantage that the device is even more compact and the distribution means cannot become lost.

The connecting means can also be disposed in any suitable manner on the base, for example can be fixedly or detachably connected therewith. However, the connecting means are expediently integrated into the base of the device.

Pursuant to another further development of the inventive teaching, a power supply unit for the distribution means is disposed on the base. This ensures that a suitable power supply unit is always available for the distribution means.

With the aforementioned embodiment, the power supply unit for the distribution means can in principle be disposed in any desired manner on the base. The power supply unit is expediently integrated into the base in order to make the device even more compact.

The invention will be explained subsequently with the aid of the accompanying drawing, in the single figure of which is illustrated one embodiment of the invention.

In the drawing, one embodiment of an inventive device for the temporary wiring of data processing networks is shown in a greatly schematic illustration in the operating condition.

The drawing shows a device 2 for the emergency wiring having a base 4, which is provided with a wiring device 6, and having connecting means 8 and distribution means that are not illustrated in the drawing. In this embodiment, the distribution means include a switch that is integrated into the base 4 of the device 2 and that is connected to a non-illustrated source of power via a voltage supply unit that is integrated into the base 4 and that is also not illustrated in the drawing.

The base 4 of the device 2 is embodied in the manner of a cable drum and thus forms the winding device 6 for the winding of a data transmission line 10, for example in the form of a cable, by means of which the device 2 can be electrically connected with a central unit 12. In this embodiment, the line 10 is fixedly connected to the base 4 of the device 2, whereas it can be plug connected with the central unit 12 via a plug that is not illustrated in the drawing. By means of the connecting means 8, the device 2 can be electrically connected with data processing units 14, whereby the connecting means 8 are integrated into the base 4 of the device 2. In this embodiment, the connecting means 8 are provided with plug connections for the connection of the data processing units 14, so that non-illustrated plugs of the data processing units 14 can be plugged directly into the base 4 for establishing a data transmission connection with the central unit 12.

When using the inventive device 2 for the emergency wiring of data processing networks, first a plug of a connector line of the network to the central unit 12, which plug is not illustrated in the drawing, is unplugged from the central unit and the also not illustrated plug of the line 10 is plugged into the central unit 12 at this location. The user then brings the unit 2 from the central unit 12 to the data processing units 14 that are to be connected to the central unit 12 and in so doing unwinds the line 12 from the winding device 6 of the device 2.

The user subsequently electrically connects the individual data processing units 14 to the device 2 by plugging their plugs into the connecting means 8 of the device 2. After the non-illustrated power supply unit of the distribution means that are not illustrated in the drawing is connected with a similarly not illustrated power source, the emergency wiring of the data processing network is established, so that operation of the data processing network can again be undertaken. During operation of the device 2, the distribution means, which are formed by a switch, switch data transmission connections, in a manner known to one that is skilled in the art, between the central unit 12 and the data processing units 14, or between the data processing units 14 themselves.

During the time that the data processing network is temporarily ensured by the device 2 for emergency wiring, technicians can search for and eliminate the cause of the network failure in peace and taking all necessary care. If this occurs, the device 2 can again be taken out of operation. This occurs in the reverse sequence to that of its being set into operation. Subsequently, the device 2 can again be stowed in a space-saving manner.

The inventive device 2 thus ensures that the operating condition of a network can be rapidly and economically established in a straightforward manner, especially after an interruption caused by a failure in the wiring.

Should the number of plug connections at the connecting means 8 provided by the inventive device 2 not be adequate in a given application in order to connect all of the data processing units 14 to the device 2, and hence to the central unit 12, it is possible to connect several inventive devices 2 in series in order in this way to be able to connect further data processing units 14 to the central unit 12. For this purpose, a connecting line of a further inventive device 2, which is not illustrated in the drawing, its connected to the device 2 via a plug connection of the connecting means 8 so that both devices are connected in series. There is then available for the connection of data processing units 14, in addition to the remaining plug connections of the connecting means 8 of the inventive device 2, the plug connections of the connecting means of the further inventive device 2. If necessary, a plurality of inventive devices 2 can be connected in series. It is also possible to connect a plurality of inventive devices 2 to one and the same inventive device 2 that is connected with the central unit 12.

The inventive device 2 is particularly suitable for the emergency wiring of data processing networks. It Is furthermore suitable for the temporary wiring of data processing networks or other communication networks, for example at concerts or other events or for technical auxiliary organizations.

1. Device (2) for the temporary wiring, especially emergency wiring, of communication networks, especially data processing networks,
with a base (4), which is provided with a winding device (6) for a line (10) for the connection of the device (2) with a central unit (12),
with connecting means (8) disposed on the base (4) for the connection of a plurality of data processing units (14) to the device (2), and
with distribution means, disposed on the base (4) and connected with the connecting means (8), for the establishment of communication connections between the central unit (12) and the data processing units (14).

2. Device according to claim 1, characterized in that the distribution means are provided with switch means.

3. Device according to claim 1, characterized in that the distribution means are provided with an active network component.

4. Device according to claim 3, characterized in that the active network component is a switch, a hub, a router or the like.

5. Device according to claim 1, characterized in that the distribution means are provided with amplification means for the amplification of signals exchanged between the central unit (12) and the data processing units (14).

6. Device according to claim 1, characterized in that the line (10) for the connection of the device (2) with the central unit (12) is fixedly connected with the base (4) of the device (2).

7. Device according to claim 1, characterized in that the connecting means (8) are provided with plug connections for the connection of the data processing units (14).

8. Device according to claim 1, characterized in that the base (4) is embodied in the manner of a cable drum and thus forms the winding device (6).

9. Device according to claim 1, characterized in that the distribution means are integrated into the base (4) of the device (2).

10. Device according to claim 1, characterized in that the connecting means (8) are integrated into the base (4) of the device (2).

11. Device according to claim 1, characterized in that a voltage supply unit for the distribution means is disposed on the base (4).

12. Device according to claim 11, characterized in that the voltage supply unit is integrated into the base (4).
